(19) United States
(12) Patent Application Publication
(10) Pub. No.: US 2007/0119093 A1
(43) Pub. Date: May 31, 2007

(54) Mobile Fishing Utility Box

(76) Inventor: Lawrence S. Jaskulski, Palmetto, FL (US)

Correspondence Address: ADVANTIA LAW GROUP, 9035 SOUTH 1300 EAST, SUITE 200, SANDY, UT, 84094, US

(21) Appl. No.: 11/164,583

(22) Filed: Nov. 29, 2005

(51) Int. Cl. A01K 97/06

(52) U.S. Cl. 43/54.1

(57) ABSTRACT

A mobile fishing box for transporting various fishing tools, including: a base, in a generally cubic shape, including four side walls, a bottom wall, a top devoid of a wall, a pair of wheels attached to the base by a shaft which passes through the base, substantially parallel to the bottom wall, and a spool through which the shaft passes, a removable compartment lid which fits into the top, and includes at least one compartment; and a removable lid which fits over the removable compartment lid.

### BACKGROUND OF THE INVENTION

The present invention relates to mobile fishing utility boxes, specifically mobile fishing utility boxes for transporting fishing tools.

### DESCRIPTION OF THE RELATED ART

In U.S. Pat. No. 6,076,298 Teel discloses a molded plastic fishing supply caddy on four traction wheels and having a foldable rear handle. The handle is locked at a 45° angle for pushing or pulling the caddy on two wheels in rough terrain or in sand. The caddy is compartmentalized with a food cooler compartment and a live bait well compartment in the rear with doubled lids. A tackle box is stored under the smaller cooler lid. A large open forward compartment carries fishing paraphernalia such as casting nets, wading boots, rain gear, folding seats, buckets, etc. An open-tubed bracket structure is provided at a forward end, for fishing rods and a beach umbrella.

Klein discloses in U.S. Pat. No. 6,374,532 a sporting apparatus, one aspect of which is a tackle box having a tackle box body and a cover with multiple mounting members on the tackle box for mounting a reel supporting rod having a reel at its upper end. A transport cart upon which the tackle box can be supported includes wheels and a handle for allowing the tackle box to be pulled by a person while supported within the cart. Another aspect concerns a resilient seat assembly that is removably mounted on the tackle box. The tackle box or a tray contained therein or other components are provided with mounting structure for holding these items on a supporting article such as a pail. The reel can be repositioned for being supported by a plurality of legs or a tripod for holding the reel in vertical alignment with a fishing hole in the ice surface, with the reel then mounted on the lower end of a tube that can be raised or lowered vertically to move it to a selected position within the water or above the ice surface and then clamped in place.

Thibodeaux discloses in U.S. Pat. No. 6,185,860 a fisherman's cooler which includes a box-shaped container having a pivotable lid for covering a substantially open top portion. The lid includes an indented portion on its upper surface having measuring indicia therein for assisting a fisherman in measuring a fish. The top portion of the container includes a plurality of fishing rod holders, the diameter of which may be varied to support varying diameter fishing rods. An accessory shelf is hingedly attached to the front wall of the container for supporting various accessory items thereon. The accessory shelf may be locked in a horizontal position with a locking mechanism.

In U.S. Pat. No. 5,864,981 Zeman discloses a new combination tackle box, bait well, and cooler for combining separate fishing equipment into a single multi-function apparatus. The inventive device includes a main body portion divided into an upper bait compartment and an upper cooler compartment, separate lids disposed over each compartment for selectively providing access to each compartment, and drawers slidably disposed below the compartments.

Downey discloses in U.S. Pat. No. 5,471,779 a fishing implement storage apparatus. The fishing implement storage apparatus includes a chest having a seat and lid pivotably coupled thereto. A handle is pivotably coupled to the chest to allow easy handling thereof. A storage compartment for housing fishing accessories is coupled to the chest. The fishing implement storage apparatus is also provided with an aerator for oxygenating water in the chest so that live bait can be stored therein. Additionally the fishing implement storage apparatus is provided with a rod holder to allow fishing without the fishing rod being hand held by a user.

What is needed is a mobile fishing utility box that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available mobile fishing utility boxes. According to one embodiment, the present invention has been developed to provide a mobile fishing box for transporting various fishing tools, including a base, in a generally cubic shape, including four side walls, a bottom wall, a top devoid of a wall, a pair of wheels attached to the base by a shaft which passes through the base, substantially parallel to the bottom wall, and a spool through which the shaft passes, a removable compartment lid which fits into the top, and includes at least one compartment, and a removable lid which fits over the removable compartment lid.

The mobile fishing box, may further include a rod holder attached to one of the four side walls. The mobile fishing box may further include an elongated member for securing a fishing rod in the rod holder. The removable lid may further include an accessory box secured to the removable lid by an elongated member, and an attachment device to which the elongated member may secure to the lid. The accessory box may be a bait box. The base may further include a pulling handle attached to a side wall furthest from the shaft. The removable compartment lid may include a handle. The removable lid may attach to the base. The spool may be a spool of fishing line or leader line. The base may further include a soft material for the attachment of hooks.

According to another embodiment of the present invention, the mobile fishing box for transporting various fishing tools, consists only of a base, in a generally cubic shape, including four side walls, a bottom wall, a top devoid of a wall, a pair of wheels attached to the base by a shaft which passes through the base, substantially parallel to the bottom wall, and a spool through which the shaft passes, a removable compartment lid which fits into the top, and includes at least one compartment, and a removable lid which fits over the removable compartment lid.

The spool may be a spool of fishing line or leader line.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates and exploded perspective view of the mobile fishing box according to one embodiment of the present invention;

FIG. 2 illustrates a perspective view of the box base of the mobile fishing box according to one embodiment of the present invention; and

FIG. 3 illustrates a side plan view of the mobile fishing box according to one embodiment of the present invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

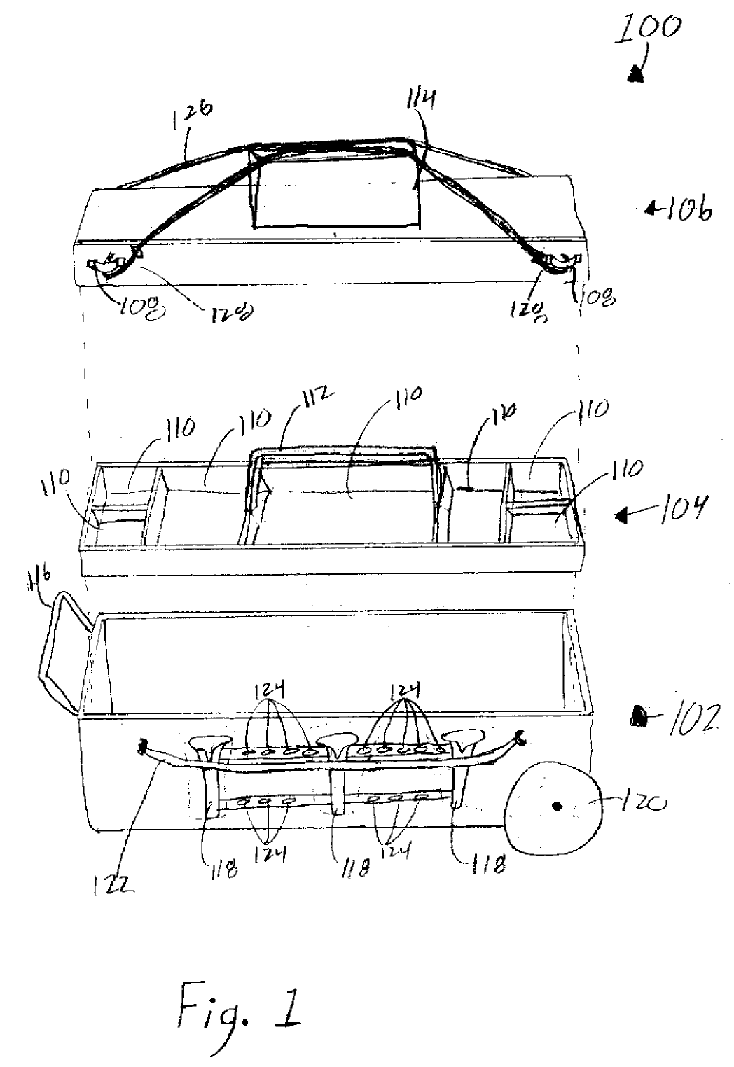

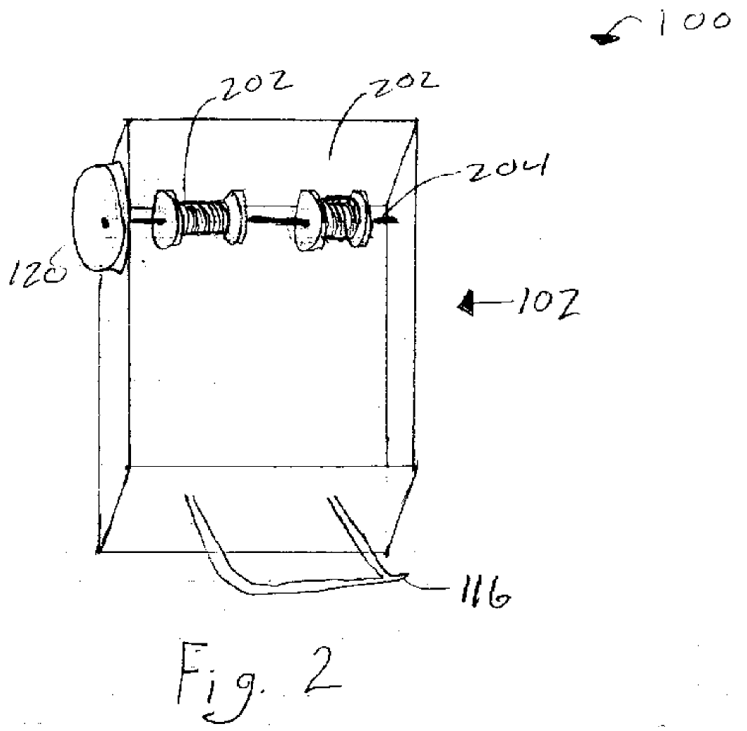

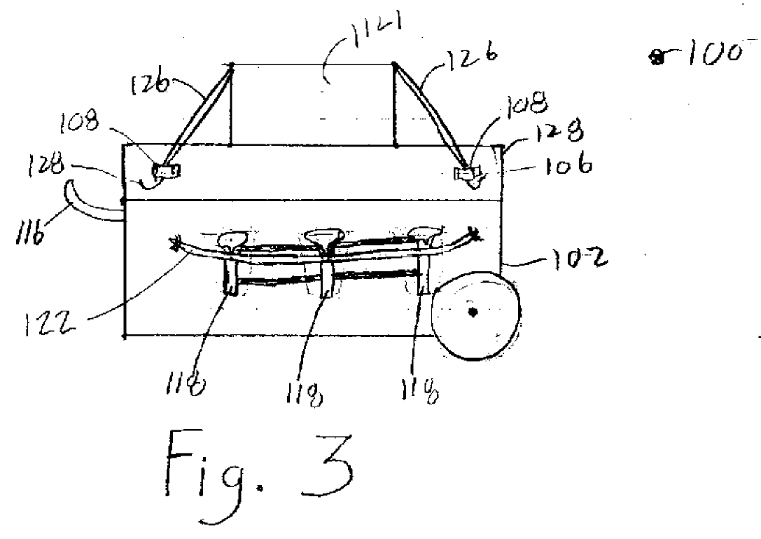

FIG. 1 illustrates a perspective exploded view of the mobile fishing box according to one embodiment of the present invention. Turning also to FIG. 2, what is illustrated is a top perspective view of the base according to one embodiment of the present invention. Further turning to FIG. 3, what is illustrated is a side plan view of the mobile fishing box according to one embodiment of the present invention.

The mobile fishing box 100 includes a base 102, a removable compartment lid 104, and a removable lid 106 which fits over the removable compartment lid. Turning more specifically to each of these three components, the base 102 may be generally in the shape of a cube with four side walls, a bottom, and a top that is devoid of a wall. The base 102 may include wheels 120 attached thereto. The wheels 120 may be attached to the base 102 by a shaft 204 that passes through the base 102. The shaft 204 may be substantially parallel to the bottom of the base 102. The base 102 may include a handle for pulling 116 that may extend from a side wall. The handle for pulling 116 may extend fro a side wall that is furthest from the shaft 204. In this way, the handle for pulling 116 may be used to lift the end of the base 102 that is furthest from the shaft 204 off of the ground, allowing the box 100 to be pulled where only the wheels 120 contact the ground. The base 102 may include a soft material for the attachment of hooks or other sharp fishing tools. This soft material may include cork, synthetic cork, foam, plastic, material and so forth. This soft material may be placed on the inside or the outside of the base member 102.

The base 102 may also include various other fishing accessories. For example, the base 102 may include one or more fishing rod holders 118. The fishing rod holders 118 may be configured to hold fishing rods. In one embodiment, the fishing rod holders 118 are in the shape of cylinders, attached to the base 102 such that the length of the cylinders run substantially perpendicular to the ground. The cylinders may have the top end open, and the bottom end closed such that when a fishing rod is placed in the fishing rod holder 118, it does not pass through the holder and fall to the ground. The fishing rod holder 118 may also have a cut-away portion. This cut-away portion may be substantially in the shape of a “V”.

There may also be an elongated member 122 that holds either the fishing rod holders 118 to the base 102, or holds fishing rods in the fishing rod holders 118. The elongated member 122 may be any known in the art. For example, the elongated member 122 may be a rope, a cord, a bungee cord, an elastic member, a wire, or so forth.

In one embodiment, there are more than one fishing rod holders 118 attached to the base 102. In yet another embodiment, there are placed utility holders 124 placed between the fishing rod holders 118. The utility holders 124 may include divots, holes, cork, hooks, or other such means for connecting fishing tools to the base 102.

Turning now to the removable compartment lid 104, this lid fits inside of the base 102. The removable compartment lid 104 may fit onto platforms or hooks inside of the base 102 such that it does not fall to the bottom of the base 102. In another embodiment, the removable compartment lid 104 includes a lip that fits over the side walls of the base 102 such that it does not fall to the bottom of the base 102. The removable compartment lid 104 may include a handle 112 on the top surface thereof such that it may be lifted off of the base 102. The handle 112 may be short enough such that when the lid 106 is placed on the box, the lid 106 may fit over the handle 112 of the removable compartment lid 104. The removable compartment lid 104 may also include compartments 110 separate by walls. The compartments 110 may be configured to keep separate tools or other items kept in the compartments 110.

Turning now to the removable lid 106, this lid may fit over the removable compartment lid 104 to cover the contents of the removable compartment lid 104 and secure to the base 102. The removable lid 106 may include loops 108 to which elongated members 126 may be attached. The elongated members 126 may include any of the types of elongated members indicated above. Elongated members 126 may be attached to the loops 108 to hold a member on the top of the removable lid 106. The member may be an accessory box 114. The accessory box 114 may hold more fishing tools, or other fishing paraphernalia. For example, the accessory box 114 may include a bait box. In one embodiment, there are two loops 108 attached to two sides each of the removable lid 106, and elongated members 126 are attached such that they cross over the top of the removable lid 106 and the accessory box 114.

The removable lid 106 may attach to the base 102. In one embodiment, the entire lid 106 is removable from the base 102 and attaches by friction between either the lid 106 and the base 102, or the lid 102 and the removable compartment lid 104. In another embodiment, there are external attachments that secure the lid 106 to the base 102. In yet another embodiment, the removable lid 106 is permanently attached to the base 102 at one end of the lid 102 such that it opens by means of swinging upwardly, as on a hinge.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A mobile fishing box for transporting various fishing tools, comprising:
a base, in a generally cubic shape, including:
four side walls;
a bottom wall;
a top devoid of a wall;
a pair of wheels attached to the base by a shaft which passes through the base, substantially parallel to the bottom wall; and
a spool through which the shaft passes;
a removable compartment lid which fits into the top, and includes at least one compartment; and
a removable lid which fits over the removable compartment lid.

2. The mobile fishing box of claim 1, further comprising a rod holder attached to one of the four side walls.

3. The mobile fishing box of claim 2, further comprising an elongated member for securing a fishing rod in the rod holder.

4. The mobile fishing box of claim 1, wherein the removable lid further comprises an accessory box secured to the removable lid by an elongated member, and an attachment device to which the elongated member may secure to the lid.

5. The mobile fishing box of claim 4, wherein the accessory box includes a bait box.

6. The mobile fishing box of claim 1, wherein the base further comprises a pulling handle attached to a side wall furthest from the shaft.

7. The mobile fishing box of claim 1, wherein the removable compartment lid includes a handle.

8. The mobile fishing box of claim 1, wherein the removable lid attaches to the base.

9. The mobile fishing box of claim 1, wherein the spool includes a spool of fishing line or leader line.

10. The mobile fishing box of claim 1, wherein the base includes a soft material for the attachment of hooks.

11. A mobile fishing box for transporting various fishing tools, consisting of:
a base, in a generally cubic shape, including:
four side walls;
a bottom wall;
a top devoid of a wall;
a pair of wheels attached to the base by a shaft which passes through the base, substantially parallel to the bottom wall; and
a spool through which the shaft passes;
a removable compartment lid which fits into the top, and includes at least one compartment; and
a removable lid which fits over the removable compartment lid.

12. The mobile fishing box of claim 11, wherein the spool includes a spool of fishing line or leader line.
